(19) United States
(12) Patent Application Publication
(10) Pub. No.: US 2003/0223908 A1
(43) Pub. Date: Dec. 4, 2003

(54) Specimen heating apparatus

(76) Inventor: Teruaki Itoh, Kumamoto-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/445,809

(22) Filed: May 28, 2003

(30) Foreign Application Priority Data
May 31, 2002 (JP) 2002-159418

(51) Int. Cl. B01L 3/00

(52) U.S. Cl. 422/63; 422/99

(57) ABSTRACT

A specimen heating apparatus heats specimen to be analyzed, which is sent into a specimen analyzing apparatus, to a given temperature. The apparatus includes a specimen heating unit placed on a route for carrying the specimen into the specimen analyzing apparatus and including a heating housing having heating tunnel through which the specimen is allowed to pass, a heat energy supply unit which circulates a thermal medium through radiator provided on walls of the heating tunnels to heat the heating tunnel to a given temperature, and air shutters provided at an entrance and an exit of the heating tunnel.

### CROSS-REFERENCE TO RELATED APPLICATIONS

This application is based upon and claims the benefit of priority from the prior Japanese Patent Application No. 2002-159418, filed May 31, 2002, the entire contents of which are incorporated herein by reference.

### BACKGROUND OF THE INVENTION

1. Field of the Invention

The present invention relates to a specimen heating apparatus for heating a specimen to be analyzed such as collected blood, which is sent into a specimen analyzing apparatus, to a given temperature.

2. Description of the Related Art

In general, when a specimen such as collected blood is analyzed by a specimen analyzing apparatus, the blood is dispensed into a sample tube and a reagent is added to the blood. After that, the blood is heated to a given temperature and sent into the specimen analyzing apparatus. Conventionally, a specimen such as collected blood was heated in a separate heating room and sent into a specimen analyzing apparatus.

It was relatively difficult to control the heating room at a constant temperature. Temperature variations therefore easily occurred among a plurality of heated specimens to be analyzed and the heated specimens were not smoothly sent into the specimen analyzing apparatus. It was therefore difficult to keep the specimens, which were supplied in sequence to the specimen analyzing apparatus, at a constant temperature level. Accordingly, there was a fear that variations due to a temperature difference among the specimens would occur in the analytic results of the specimens.

### BRIEF SUMMARY OF THE INVENTION

An object of the present invention is to provide a specimen heating apparatus capable of stably keeping a temperature level of specimens to be analyzed, which are sent into a specimen analyzing apparatus, to a given level and eliminating variations in the analytic results due to a temperature difference among the specimens.

In order to attain the above object, the specimen heating apparatus according to the present invention has the following characteristic configuration. The other characteristic configurations will be clarified in the Embodiment later.

A specimen heating apparatus which heats specimen to be analyzed, sent into a specimen analyzing apparatus, to a given temperature, comprises a specimen heating unit placed on a route for carrying the specimen into the specimen analyzing apparatus and including a heating housing having heating tunnel through which the specimen is allowed to pass, a heat energy supply unit which circulates a thermal medium through radiator provided on wall of the heating tunnel to heat the heating tunnel to a given temperature, and air shutters provided at an entrance and an exit of the heating tunnel.

In the specimen heating apparatus, the hating tunnel whose entrances and exits are shielded with the air shutters are stably heated and maintained at a given temperature by the heat energy supply unit of a thermal medium circulating type. The specimen to be analyzed is heated when they pass through the heating tunnel that is heated under very stable heating condition. Therefore, the specimen is heated to a given temperature with precision. The heated specimen is smoothly sent into the specimen analyzing apparatus through the exit air shutters. As a result, the temperature of the specimen sent into the specimen analyzing apparatus is always set at a given level regardless of the condition, such as the time when a specimen is heated.

### BRIEF DESCRIPTION OF THE SEVERAL VIEWS OF THE DRAWING

FIG. 1 is a block diagram schematically showing a configuration of a specimen heating apparatus according to an embodiment of the present invention;

FIG. 2 is a perspective view specifically showing a configuration of a specimen heating unit, together with a heat energy supply unit, in the specimen heating apparatus according to the embodiment of the present invention;

FIG. 3 is a diagram specifically showing the specimen heating unit and heat energy supply unit of the specimen heating apparatus according to the embodiment of the present invention;

FIG. 4A is a sectional front view of the specimen heating unit; and

FIG. 4B is a sectional side view of the specimen heating unit.

### DETAILED DESCRIPTION OF THE INVENTION

(Embodiment)

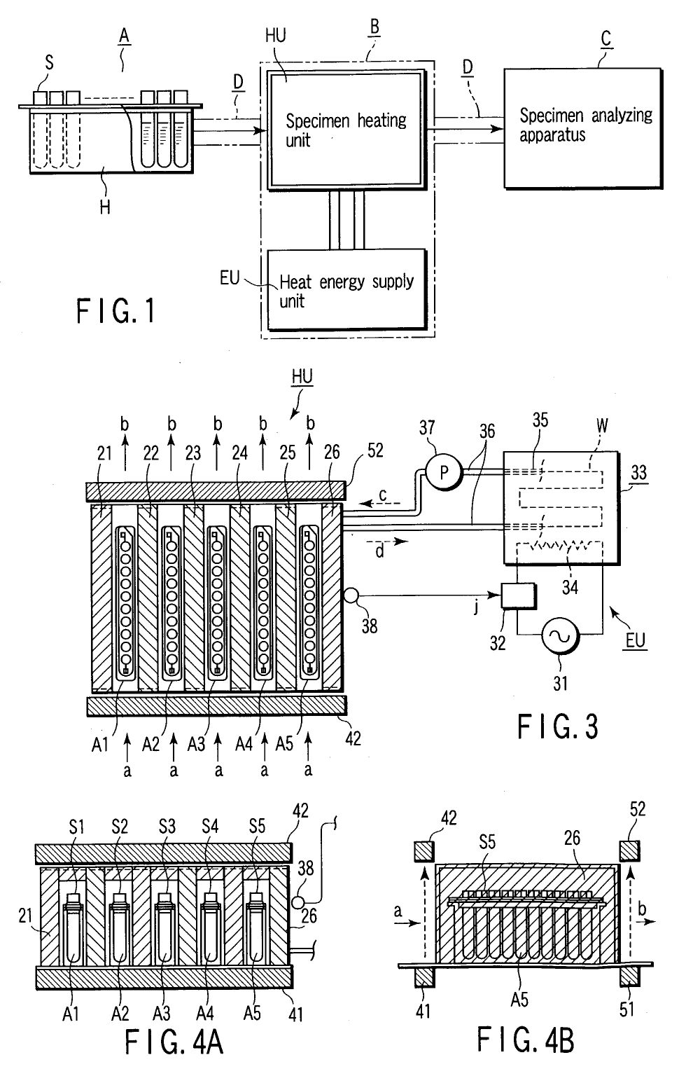

FIG. 1 is a block diagram schematically showing a configuration of a specimen heating apparatus according to an embodiment of the present invention. As shown in FIG. 1, a specimen heating apparatus B heats a specimen A to be analyzed (a plurality of specimen-containing sample tubes S that are held by a holder H) to a temperature suitable for the analysis and sends the heated specimen A into a specimen analyzing apparatus C.

The specimen heating apparatus B includes a specimen heating unit HU and a heat energy supply unit EU. The specimen heating unit HU has a heating housing (described later) that is placed on a route D for carrying the specimen A into the specimen analyzing apparatus C. The heat energy supply unit EU supplies heat energy to the specimen heating unit HU to heat the unit HU.

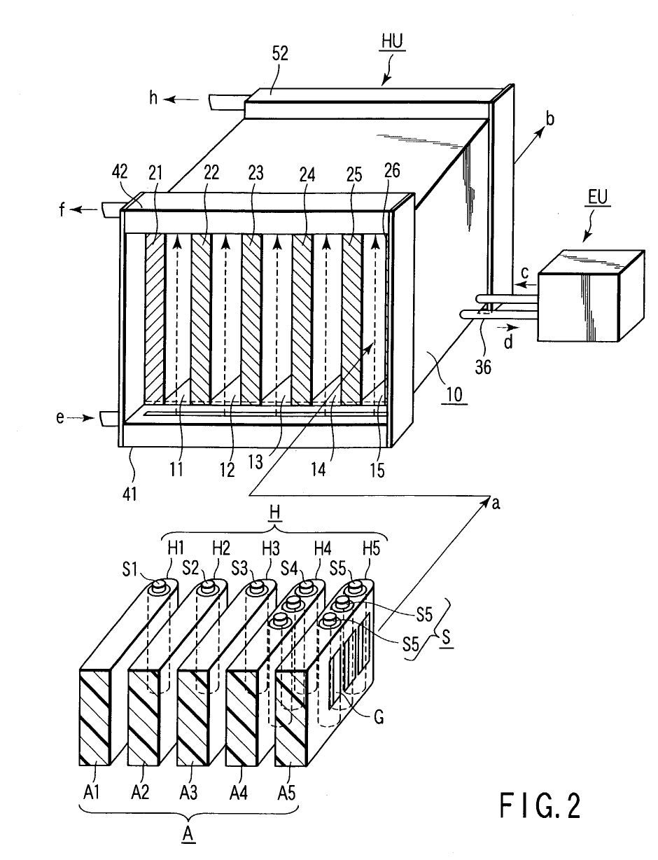

FIG. 2 is a perspective view specifically showing a configuration of the specimen heating unit HU, together with the heat energy supply unit EU. As shown in FIG. 2, the specimen heating unit HU includes a heating housing 10 having a plurality of heating tunnels 11 to 15 through which the specimen A (A1 to A5) is allowed to pass. The walls of the heating tunnels 11 to 15 are made up of radiators 21 to 26 for heating the insides of the tunnels 11 to 15 to a given temperature. The radiators 21 to 26 are supplied with a thermal medium such as heated water from the heat energy supply unit EU through a pipe 36. The thermal medium therefore circulates in a given route. The holder H (H1 to H5) has a through-hole G in its sidewalls such that heat in the heating tunnels 11 to 15 can be transmitted to the sample tube S (S1 to S5) with efficiency.

The entrance of each of the heating tunnels 11 to 15 has entrance air shutters 41 and 42 that are opposed to each other in the vertical direction and the exit thereof has exit air shutters 51 and 52 that are also opposed to each other in the vertical direction. The entrance air shutters 41 and 42 receive compressed air as indicated by arrows e and f and shield the entrance of each of the heating tunnels 11 to 15 with an air curtain. The exit air shutters 51 and 52 receive compressed air as indicated by arrows g (not shown) and h and shield the exit of each of the heating tunnels 11 to 15 with an air curtain.

Since the heating tunnels 11 to 15 are arranged in parallel, the specimens A1 to A5 to be analyzed can pass through their respective tunnels in parallel. Though not shown, a conveying mechanism such as a belt conveyor is provided such that the specimens A1 to A5 can smoothly go into and go out of the heating tunnels 11 to 15.

FIG. 3 is a diagram specifically showing the specimen heating unit HU and heat energy supply unit EU. Referring to FIG. 3, in the heat energy supply unit EU, electrical energy is supplied to a heater 34 in a heat exchanger 33 from a power supply 31 via a current control device 32 such as a thyristor. Thus, the heater 34 generates heat by which a heating pipe 35 formed in the heat exchanger 33 is heated. Consequently, a thermal medium W (e.g., water) flowing through the pipe is heated and compressively supplied to the radiators 21 to 26 through the pipe 36 using a circulation pump 37. Thus, the thermal medium W having a give temperature circulates in the radiators 21 to 26.

An electric current which is supplied to the heater 34 is controlled by the current control device 32 that is provided between the power supply 31 and the heater 34. The current control device 32 is controlled by feeding a signal indicated by arrow j back to the current control device 32 from a temperature sensor 38 which senses the temperature of the radiators 21 to 26 and the inside temperature of the heating tunnels 11 to 15. Thus, the heating tunnels 11 to 15 are automatically maintained at a given temperature.

In the specimen heating apparatus B so configured, the specimens A1 to A5 to be analyzed (which are held by the holders H1 to H5, respectively, and include specimen-containing sample tubes S1, specimen-containing sample tubes S2, specimen-containing sample tubes S3, specimen-containing sample tubes S4 and specimen-containing sample tubes S5, respectively) are smoothly introduced into their respective heating tunnels 11 to 15 through the air curtains formed by the entrance air shutters 41 and 42 provided at the entrances of the heating tunnels 11 to 15, as indicated by arrows a. The inside of the heating tunnels 11 to 15 is all uniformly heated to a given temperature by the heat energy supply unit EU. Hence, the specimens A1 to A5 introduced into the heating tunnels 11 to 15 are all uniformly heated to a given temperature. The specimens A1 to A5 heated to the given temperature are smoothly carried into the specimen analyzing apparatus C through the air curtains formed by the exit air shutters 51 and 52 provided at the exits of the heating tunnels 11 to 15, as indicated by arrows b.

(Features of the Embodiment)

[1] A specimen heating apparatus B according to an embodiment of the present invention, which heats specimen A to be analyzed, sent into a specimen analyzing apparatus C, to a given temperature, comprising:

a specimen heating unit HU placed on a route D for carrying the specimen A into the specimen analyzing apparatus C and including a heating housing 10 having heating tunnel through which the specimen A is allowed to pass;

a heat energy supply unit EU which circulates a thermal medium through radiator provided on wall of the heating tunnel to heat the heating tunnel to a given temperature; and

air shutters 41 and 42 and 51 and 52 provided at an entrance and an exit of the heating tunnel.

In the specimen heating apparatus B, the hating tunnel whose entrances and exits are shielded with the air shutters 41 and 42 and 51 and 52 are stably heated and maintained at a given temperature by the heat energy supply unit EU of a thermal medium circulating type. The specimen to be analyzed is heated when they pass through the heating tunnel that is heated under very stable heating condition as described above. Therefore, the specimen is heated to a given temperature with precision. The heated specimen is smoothly sent into the specimen analyzing apparatus C through the exit air shutters 51 and 52. As a result, the temperature of the specimen sent into the specimen analyzing apparatus C is always set at a given level regardless of the condition, such as the time when a specimen is heated. It is thus possible to eliminate variations in analytic results due to a temperature difference among the specimens.

[2] The specimen heating apparatus B according to the above item [1], wherein the heating housing 10 has a plurality of heating tunnels 11 to 15 which are arranged in parallel, and a plurality of specimens A1 to A5 are allowed to pass respectively through the heating tunnels 11 to 15 in parallel. In the foregoing specimen heating apparatus B, the specimens A1 to A5 are heated to a constant temperature level at the same time. Thus, they can be heated with efficiency, which is very favorable for the speedup of clinical tests. In this case, too, the specimens A1 to A5 are heated under the same conditions as those in the above item [1] and sent into the specimen analyzing apparatus C. As a result, the temperature of the specimens A1 to A5 sent into the specimen analyzing apparatus C is always set at a given level regardless of the conditions, such as the place (in each of the heating tunnels) where a specimen is heated and the time when it is heated. It is thus possible to eliminate variations in analytic results due to a temperature difference between the specimens A1 to A5.

[3] The specimen heating apparatus B according to one of the above items [1] and [2], wherein the heat energy supply unit EU circulates a thermal medium W (e.g., liquid such as water), which is heated by a heater 34, through the radiator using a circulation pump 37.

In the above specimen heating apparatus B, the thermal medium W is forcibly circulated by the circulation pump 37 and thus heat energy is transmitted smoothly and stably. Consequently, the specimen is always heated with stability.

(Modifications)

The specimen heating apparatus according to the embodiment can be modified as follows:

The radiators 21 to 26 can be detached from the walls of the heating tunnels 11 to 15, respectively; and

Temperature sensors can be attached to their respective heating tunnels 11 to 15 to thermally control the heating tunnels 11 to 15 in response to feedback signals from the temperature sensors.

What is claimed is:

1. A specimen heating apparatus which heats specimen to be analyzed, sent into a specimen analyzing apparatus, to a given temperature, comprising:
a specimen heating unit placed on a route for carrying the specimen into the specimen analyzing apparatus and including a heating housing having heating tunnel through which the specimen is allowed to pass;
a heat energy supply unit which circulates a thermal medium through radiator provided on wall of the heating tunnel to heat the heating tunnel to a given temperature; and
air shutters provided at an entrance and an exit of the heating tunnel.

2. The specimen heating apparatus according to claim 1, wherein the heating housing has a plurality of heating tunnels which are arranged in parallel, and a plurality of specimens are allowed to pass respectively through the heating tunnels in parallel.

3. The specimen heating apparatus according to claim 1, wherein the heat energy supply unit circulates a thermal medium, which is heated by a heater, through the radiator using a circulation pump.

4. The specimen heating apparatus according to claim 2, wherein the heat energy supply unit circulates a thermal medium, which is heated by a heater, through the radiators using a circulation pump.
